(19) United States
(12) Patent Application Publication
(10) Pub. No.: US 2019/0220948 A1
(43) Pub. Date: Jul. 18, 2019

(54) METHOD AND ASSOCIATED PROCESSOR FOR BUFFER SWAP

(71) Applicant: MEDIATEK INC., Hsin-Chu City (TW)

(72) Inventors: Su-Ting CHUANG, New Taipei City (TW); Yuan-Chung SHEN, Taipei City (TW)

(21) Appl. No.: 15/869,267

(22) Filed: Jan. 12, 2018

(51) Int. Cl. G06T 1/60

(52) U.S. Cl. CPC G06T 1/60

(57) ABSTRACT

The invention provides method and associated processor for buffer swap which swaps a plurality of buffers to respectively be a front buffer and a number of back buffers, enables a frame drawn to the front buffer to be read, and draws another frame to one of said back buffers. The method comprises: iterating a procedure for drawing each one of a sequence of frames, wherein the procedure comprises: selecting one of a plurality of swap behaviors according to input data, and performing the buffer swap by the selected swap behavior.

### FIELD OF THE INVENTION

The present invention relates to method and associated processor for buffer swap, and more particularly, to method and associated processor for buffer swap by selecting swap behaviors according to input data, which may reflect chip type, power status, custom setting and/or whether difference between frames is greater than a threshold.

### BACKGROUND OF THE INVENTION

Graphic user interface is broadly adopted by modern electronic devices, such as mobile phones, smart phones, digital cameras, camcorders, navigators, game consoles, handheld computers and wearable gadgets, etc. Graphic user interface is implemented by drawing and displaying a sequence of frames.

For efficiency of implementing graphic user interface, multiple buffering, such as double buffering, is utilized by performing plural iterations of a buffer swap respectively for plural frames. Each iteration of the buffer swap may include swapping multiple buffers to respectively be a front buffer and back buffer(s), so a frame already drawn to the front buffer in a preceding iteration of the buffer swap may be read (e.g., for display), and consecutive frame(s) may be drawn to the back buffer(s).

For example, to implement double buffering by a first buffer and a second buffer, in a first iteration of buffer swap, the first buffer may be the front buffer providing a first frame for display, and the second buffer may be the back buffer allowing a second frame to be drawn to; then, in a second iteration of buffer swap, the second buffer may be the front buffer providing the second frame for display, and the first buffer may be the back buffer allowing a third frame to be drawn to.

### SUMMARY OF THE INVENTION

Buffer swap may be performed by different swap behaviors. An objective of the invention is providing a method (e.g., 400 in FIG. 4) for buffer swap which swaps a plurality of buffers (e.g., B0 and B1 in FIG. 1) to respectively be a front buffer and a number (e.g., one) of back buffers, enables a frame drawn to the front buffer to be read, and draws another frame to one of said back buffers. The method may comprise: by a processor (e.g., 104 in FIG. 1), iterating a procedure (e.g., 404. 406 and 408 collectively, FIG. 4) for drawing each one of a sequence of frames (e.g., f[p] or f[q] in FIG. 5a or 5b), wherein the procedure may comprise: by the processor, selecting one of a plurality of swap behaviors according to input data (e.g., 404 in FIG. 4), such that there may be at least two iterations of the procedure in which different said swap behaviors are selected; and, performing the buffer swap by the selected one of said swap behaviors (e.g., 406).

In an embodiment (e.g., FIG. 5a), the plurality of swap behaviors may comprise a preserve behavior, and performing the buffer swap by the preserve behavior may comprise: copying (e.g., 410a in FIG. 4) the front buffer to said one of said back buffers, and drawing (e.g., 414a) a current frame (e.g., f[p] in FIG. 5) to said one of said back buffers by updating values of at least one pixel in a draw region (e.g., d[p]) reflecting a difference between the current frame (e.g., f[p]) and a preceding frame (e.g., f[p−1]) drawn in a preceding iteration (e.g., E[p]) of the procedure.

In an embodiment (e.g., FIG. 5b), the plurality of swap behaviors may comprise a buffer damage behavior, and performing the buffer swap by the buffer damage behavior may comprise: drawing (e.g., 412b in FIG. 4) a current frame (e.g., f[q] in FIG. 5b) to said one of said back buffers by updating values of at least one pixel in a draw region, wherein the draw region may reflect a union of a dirty region (e.g., d[q]) and a damage region (e.g., d[q−1]), the dirty region may reflect a difference between the current frame (e.g., f[q]) and a preceding frame (e.g., f[q−1]) drawn in a preceding iteration (e.g., E[q−1]) of the procedure, and the damage region (e.g., d[q−1]) may reflect a difference between contents of said back buffer(s) in the preceding iteration of the procedure and contents of said back buffer(s) in an earlier iteration (e.g., E[q−2]) of the procedure, wherein the earlier iteration of the procedure is prior to the preceding iteration of the procedure.

In an embodiment (e.g., FIG. 4), the plurality of swap behaviors may comprise a destroy behavior, and performing the buffer swap by the destroy behavior may comprise: drawing (e.g., 410c) a current frame to said one of said back buffers by updating values of all pixels in said one of said back buffers.

In an embodiment, the procedure may further comprise: generating current output data (e.g., 408), and performing the buffer swap according to preceding output data generated in a preceding iteration of the procedure. The current output data may include a dirty region (e.g., d[q] in FIG. 5b) reflecting a difference between a current frame (e.g., f[q]) to be drawn in a current iteration (e.g., E[q]) of the procedure and a preceding frame (e.g., f[q−1]) drawn in the preceding iteration (e.g., E[q−1]) of the procedure.

In an embodiment (e.g., FIG. 4), selecting one of the plurality of swap behaviors according to the input data may comprise (e.g., 4042 in FIG. 4): calculating a reference region at least according to a preceding frame drawn in the preceding iteration of the procedure and a current frame to be drawn in a current iteration of the procedure; and, comparing if the reference region is greater than a threshold, and including the comparison result in the input data. In an embodiment, selecting one of the plurality of swap behaviors according to the input data may further comprise: selecting a preserve behavior if the reference region is greater than the threshold, and selecting a buffer damage behavior if the reference region is not greater than the threshold.

In an embodiment, the reference region may be calculated by a difference between the current frame to be drawn in the current iteration of the procedure, and the preceding frame drawn in the preceding iteration of the procedure. In an embodiment, the reference region may be calculated by a union of a dirty region and a damage region; the dirty region may be calculated by a difference between the current frame to be drawn in the current iteration of the procedure and the preceding frame drawn in the preceding iteration of the procedure, and the damage region may be calculated by a difference between contents of said back buffer(s) in the preceding iteration of the procedure and contents of said back buffer(s) in an earlier iteration of the procedure, wherein the earlier iteration of the procedure is prior to the preceding iteration of the procedure.

In an embodiment, the input data may comprise at least one of the following: a chip type of the processor, a power status reflecting whether the processor is powered by battery, a custom setting, and result of comparing if a reference region is greater than a threshold. The reference region may be one of the following: a dirty region, and a union of the dirty region and a damage region.

An objective of the invention is providing a processor (e.g., 104 in FIG. 1) of an electronic device (e.g., 110). The processor may comprise: an access circuit (e.g., 102) for accessing a plurality of buffers (e.g., B0 and B1), and a processing unit (e.g., 100) coupled to the access circuit, for selecting among different swap behaviors according to input data to perform different iterations of a buffer swap. In each said iteration of the buffer swap, the plurality of buffers may be swapped to respectively be a front buffer and a number of back buffers, and the processing unit may draw one of a sequence of frames to one of said back buffers.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a device according to an embodiment of the invention;

FIG. 2a (prior art) and FIG. 2b (prior art) illustrate examples of different swap behaviors applicable to the device in FIG. 1;

FIG. 3a and FIG. 3b illustrate examples of performing buffer swap by the swap behaviors respectively shown in FIG. 2a and FIG. 2b;

FIG. 4 illustrates a flowchart for buffer swap according to an embodiment of the invention; and

FIG. 5a and FIG. 5b illustrates examples of executing the flowchart in FIG. 4.

### DETAILED DESCRIPTION OF PREFERRED EMBODIMENTS

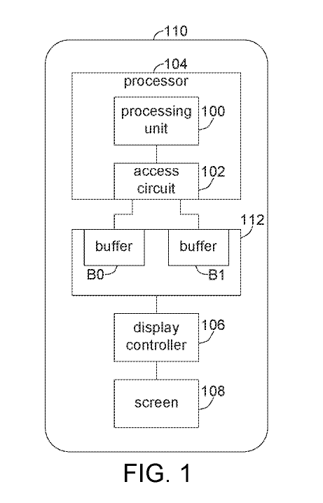

Please refer to FIG. 1 illustrating an electronic device 110 according to an embodiment of the invention. The device 110 may be a mobile device, such as a mobile phone, a smart phones, a digital camera, a camcorder, a navigator, a game console, a handheld computers or a wearable gadget, etc. The device 110 may include a processor 104, a buffer module 112, a display controller 106 and a screen 108. The buffer module 112 may be coupled between the processor 104 and the display controller 106, and may include a plurality of buffers (e.g., volatile memories) for multiple buffering, e.g., two buffers B0 and B1 for double buffering. The processor 104 may execute software codes such as applications. The processor 104 may include an access circuit 102 coupled to the buffer module 112 for accessing the buffers, and a processing unit 100 coupled to the access circuit 102 for implement a UI (user interface) engine to provide a graphic user interface for each application. For example, the processing unit 100 may be a GPU (graphic processing unit) and/or a digital logic circuit executing graphic processing software and/or firmware. The display controller 106 may be coupled between the buffer module 112 and the screen 108.

While implementing a UI engine for an application, the processing unit 100 may perform multiple iterations of buffer swap to draw (calculating and/or writing) a serial of associated graphic contents (e.g., a sequence of frames) of the application to the buffer module 112 via the access circuit 102. In each iteration of buffer swap, the buffers B0 and B1 may be swapped to respectively be a front buffer and a back buffers; a preceding frame drawn to the front buffer in a preceding iteration of buffer swap may be read by the display controller 106 and then be displayed on the screen 108, and a current frame may be drawn to the back buffer by the processing unit 100.

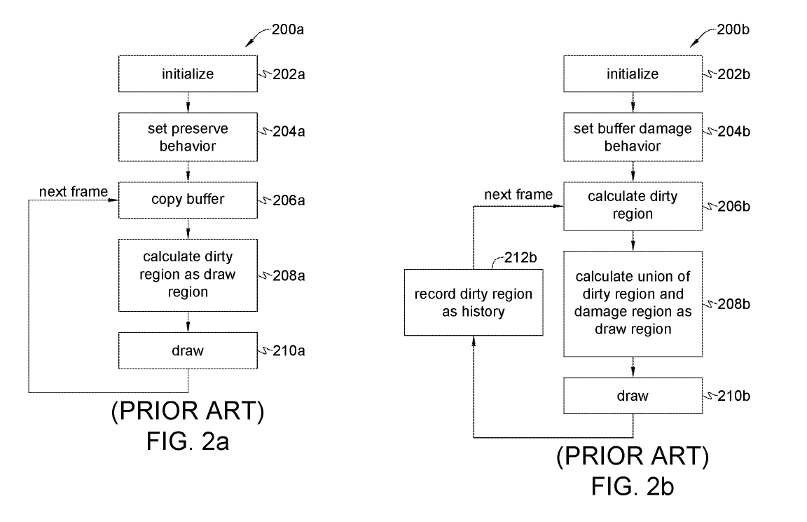

Buffer swap may be performed by different swap behaviors. Along with FIG. 1, please refer to FIGS. 2a and 2b illustrating two examples of swap behaviors by which the processing unit 100 may performed buffer swap. Following a flowchart 200a shown in FIG. 2a, the processing unit 100 may perform iterations of buffer swap by a preserve behavior. Following a flowchart 200b shown in FIG. 2b, the processing unit 100 may perform iterations of buffer swap by a buffer damage behavior.

Main steps of the flowchart 200a shown in FIG. 2a may be described as follows.

Step 202a: the processing unit 100 may initialize implementation of a UI engine and execution of buffer swap.

Step 204a: the processing unit 100 may set to adopt the preserve behavior to perform iterations of buffer swap, wherein each iteration of buffer swap may include the subsequent steps 206a, 208a and 210a.

Step 206a: the processing unit 100 may copy a preceding frame in the front buffer to the back buffer, so the front buffer and the back buffer may store the same frame. The preceding frame in the front buffer is drawn in a preceding iteration of buffer swap.

Step 208a: the processing unit 100 may calculate a dirty region as a draw region, with the dirty region reflecting a difference between the preceding frame drawn in the preceding iteration and a current frame to be drawn in a current iteration.

Step 210a: the processing unit 100 may draw the current frame to the back buffer by updating values of at least one pixel in the draw region, and iterate to step 206a with the buffers B0 and B1 swapped.

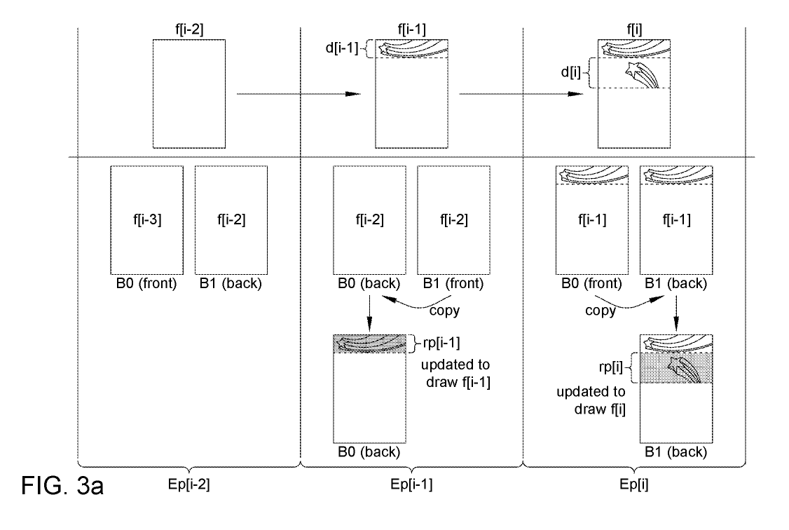

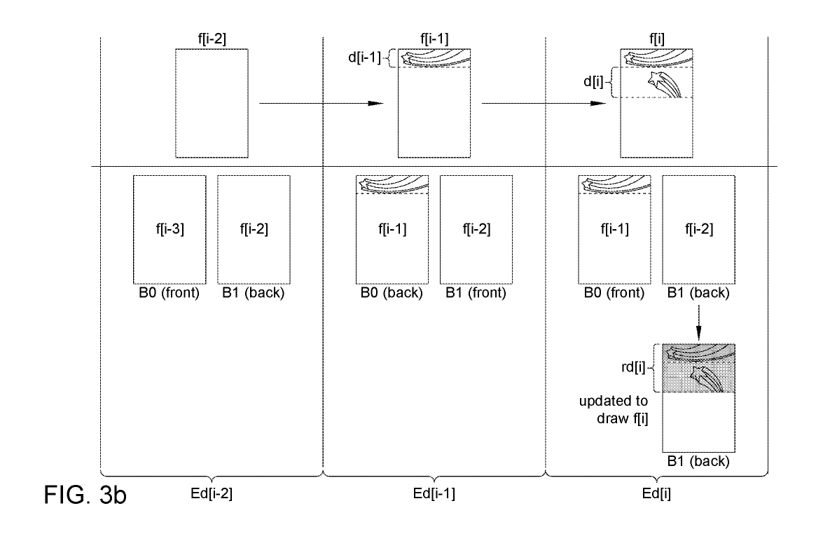

Along with FIGS. 1 and 2a, please refer to FIG. 3a illustrating an example in which iterations Ep[i−2], Ep[i−1] and Ep[i] of buffer swap are performed by the preserve behavior for respectively drawing a sequence of frames f[i−2], f[i−1] and f[i]. In the iteration Ep[i−2], it is assumed that the buffers B0 and B1 are respectively the front buffer and the back buffer. When the iteration Ep[i−2] completes, the buffers B0 and B1 respective stores the frames f[i−3] and f[i−2]. With the buffers B0 and B1 swapped to respectively be the back buffer and the front buffer, the processing unit 100 may execute the iteration Ep[i−1] by: in step 206a, copying the frame f[i−2] of the (front) buffer B1 to the (back) buffer B0. Then, in step 208a, the processing unit 100 may calculate a dirty region d[i−1] as a draw region rp[i−1], with the dirty region d[i−1] reflecting a difference between the frame f[i−1] to be drawn in the current iteration Ep[i−1] and the frame f[i−2] drawn in the iteration Ep[i−2]. Thus, in step 210a, the processing unit 100 may draw the current frame f[i−1] to the (back) buffer B00 by updating values of at least one pixel in the draw region rp[i−1].

As the iteration Ep[i−1] completes, the processing unit 100 may iterate to step 206a for the next iteration Ep[i], with the buffers B0 and B1 swapped to respectively be the front buffer and the back buffer. The processing unit 100 may execute the iteration Ep[i] by: in step 206a, copying the frame f[i−1] of the (front) buffer B0 to the (back) buffer B1. Then, in step 208a, the processing unit 100 may calculate a dirty region d[i] as a draw region rp[i], with the dirty region d[i] reflecting a difference between the frame f[i] to be drawn in the current iteration Ep[i] and the frame f[i−1] drawn in the iteration Ep[i−1]. Thus, in step 210a, the processing unit 100 may draw the current frame f[i] to the (back) buffer B1 by updating values of at least one pixel in the draw region rp[i].

Main steps of the flowchart 200b shown in FIG. 2b may be described as follows.

Step 202b: the processing unit 100 may initialize implementation of a UI engine and execution of buffer swap.

Step 204b: the processing unit 100 may set to adopt the buffer damage behavior to perform iterations of buffer swap, wherein each iteration of buffer swap may include the subsequent steps 206b, 208b, 210b and 212b.

Step 206b: the processing unit 100 may calculate a dirty region reflecting a difference between a current frame to be drawn in a current iteration and a preceding frame drawn in a preceding iteration.

Step 208b: the processing unit 100 may calculate a union of the dirty region and a damage region as a draw region, with the damage region reflecting a difference between contents of back buffer(s) in the preceding iteration of the procedure and contents of back buffer(s) in an earlier iteration of the procedure, wherein the earlier iteration of the procedure is prior to the preceding iteration of the procedure.

Step 210b: the processing unit 100 may draw the current frame to the back buffer by updating values of at least one pixel in the draw region.

Step 212b: the processing unit 100 may record the dirty region as a history, and iterate to step 206b with the buffers B0 and B1 swapped.

Along with FIGS. 1 and 2b, please refer to FIG. 3b illustrating an example in which iterations Ed[i−2], Ed[i−1] and Ed[i] of buffer swap are performed by the buffer damage behavior for respectively drawing a sequence of frames f[i−2], f[i−1] and f[i]. In the iteration Ed[i−2], it is assumed that the buffers B0 and B1 are respectively the front buffer and the back buffer; in the iteration Ed[i−1], the buffers B0 and B1 are swapped to respectively be the back buffer and the front buffer. When the iteration Ed[i−2] completes, the (front) buffer B0 and the (back) buffer B1 respective stores the frames f[i−3] and f[i−2]; when the iteration Ed[i−1] completes, the (back) buffer B0 and the (front) buffer B1 respective stores the frames f[i−1] and f[i−2]. Then, with the buffers B0 and B1 swapped to respectively be the front buffer and the back buffer, the processing unit 100 may execute the iteration Ed[i] by: in steps 206b, calculating a dirty region d[i] reflecting a difference between a current frame f[i] to be drawn in a current iteration Ed[i] and the preceding frame f[i−1] drawn in the preceding iteration Ed[i−1]. In step 208b, the processing unit 100 may calculate a draw region rd[i] reflecting a union of the dirty region d[i] and a damage region d[i−1], with the damage region d[i−1] reflecting a difference between contents of the back buffer (B0) in the preceding iteration Ed[i] and contents of the back buffer (B1) in the earlier iteration Ed[i−2]. In the example shown in FIG. 3b, the damage region d[i−1] also reflects a difference between the preceding frame f[i−1] and the earlier frame f[i−2] drawn in the earlier iteration Ed[i−2] prior to the preceding iteration Ed[i−1]. Thus, in step 210a, the processing unit 100 may draw the current frame f[i] to the (back) buffer B1 by updating values of at least one pixel in the draw region rd[i].

It is noted that the damage region d[i−1] is the dirty region of the iteration Ed[i−1]. In other words, after the processing unit 100 calculates the dirty region d[i−1] in step 206b of the iteration Ed[i−1], the dirty region d[i−1] may be stored as a history in step 212b of the iteration Ed[i−1], and be utilized as the damage region in step 208b of the subsequent iteration Ed[i]. Similarly, the dirty region d[i] calculated in step 206a of the iteration Ed[i] may be stored as a history in step 212b of the iteration Ed[i], and be utilized as the damage region in step 208b of a subsequent iteration Ed[i+1] (not shown).

Each of the swap behaviors has its own merits. Buffer swap by the preserve behavior (FIGS. 2a and 3a) requires to copy all pixel values of an entire frame from one buffer to another (step 206a in FIG. 2a) in each iteration, and such frame copying may consume considerable time, bus bandwidth and power, since copying involves both read and write. Buffer swap by the buffer damage behavior does not need to copy an entire frame between buffers in each iteration. On the other hand, in some scenarios such as the examples of FIGS. 3a and 3b, draw region (e.g., rd[i] in FIG. 3b) of the buffer damage behavior may be larger than draw region (e.g., rp[i] in FIG. 3a) of the preserve behavior, and updating at least one pixel value of a larger draw region may consume more time and power. Keeping on adopting a same swap behavior for all applications and/or for all frames of an application will lead to unnecessary waste of time and power.

Rather than maintaining a same swap behavior for all applications and/or for all frames of an application, the processing unit 100 of the invention may perform buffer swap by changing swap behaviors according to input data, which may reflect chip type, power status, custom setting and/or whether difference between frames is greater than a threshold, etc. In some embodiments, changing swap behaviors can be performed automatically, adaptively, flexibly and/or dynamically. The processing unit 100 may therefore change among different swap behaviors in response to different contents of input data to perform different iterations of buffer swap for respectively drawing a sequence of frames. For example, the processing unit 100 may adopt different swap behaviors respectively for different applications; and/or, when implementing a UI engine for an application, the processing unit 100 may adopt different swap behaviors for different iterations of buffer swap to draw frames for the same application.

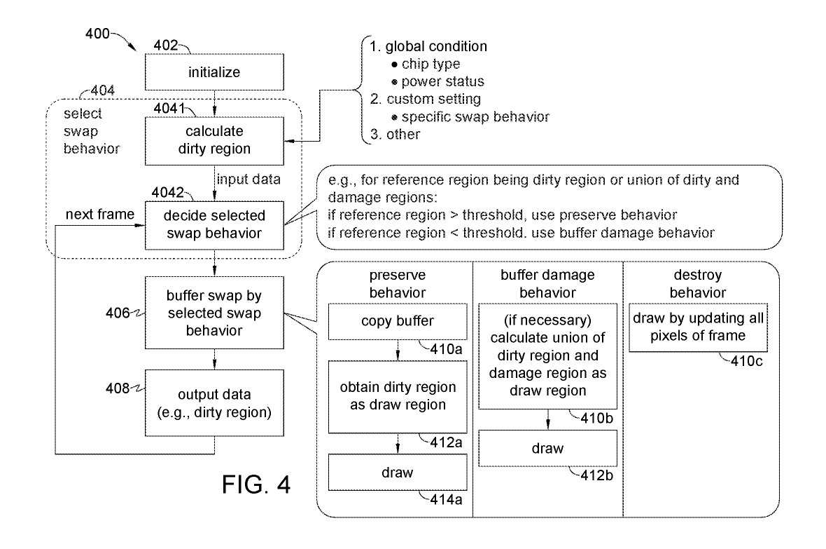

Along with FIG. 1, please refer to FIG. 4 illustrating a flowchart 400 according to an embodiment of the invention; the processing unit 100 may apply the flowchart 400 to perform buffer swap by automatic selection of swap behaviors. Main steps of the flowchart 400 may be described as follows.

Step 402: the processing unit 100 of the processor 104 may initialize implementation of a UI engine and execution of buffer swap, and then iterate a procedure including successive steps 404, 406 and 408, so as to swap buffer and draw a frame to the back buffer in each iteration of the procedure.

Step 404: the processing unit 100 may select one of a plurality of swap behaviors according to input data; and the plurality of swap behaviors may include a preserve behavior, a buffer damage behavior, a destroy behavior, etc. In some embodiments, the processing unit 100 may select one of a plurality of swap behaviors automatically. Step 404 may include steps 4041 and 4042.

In step 4041, the processing unit 100 may calculate a dirty region reflecting a difference between a current frame to be drawn in a current iteration and a preceding frame drawn in the preceding iteration. In an embodiment, the processing unit 100 may adopt the dirty region as a reference region. In a different embodiment, the processing unit 100 may further calculate a union of the dirty region and a damage region as the reference region, wherein the damage region is calculated by a difference between contents of back buffer(s) in the preceding iteration and contents of back buffer(s) in an earlier iteration, wherein the earlier iteration is prior to the preceding iteration.

With the reference region obtained, the processing unit 100 may compare if the reference region is greater than a threshold, and include the comparison result in the input data. In addition to the comparison result, the input data may further comprise: global condition(s) including a chip type of the processor 104 and/or a power status reflecting whether the processor 104 or the device 110 is powered by battery or by power cord, a custom setting indicating whether to adopt a specific swap behavior for a specific scenario, and/or other factor(s).

In step 4042, the processing unit 100 may decide swap behavior according to the input data, such that different swap behaviors may be selected.

For example, if the chip type reflects that the processor 104 has limited bus bandwidth, then the processing unit 100 may select the buffer damage behavior. If the chip type reflects that the processor 104 has sufficient bus bandwidth, then the processing unit 100 may select the preserve behavior. Some types of chips may only support preserve behavior and destroy behavior, so the processing unit 100 may switch between these two swap behaviors; some other types of chip may support three or more swap behavior, and the processing unit 100 may switch between these three or more swap behavior. For low-level chip, the processing unit 100 may select the destroy behavior; for high-level chip, the processing unit 100 may select the buffer damage behavior or the preserve behavior. Similarly, if the custom setting reflects that the current application for which the processing unit 100 implements the UI engine is suitable to a specific swap behavior, then the processing unit 100 may select that specific swap behavior. If the power status indicates that the device 110 (FIG. 1) is powered by power cord, the processing unit 100 may select a swap behavior which trades power for efficiency. In an embodiment example, when the power status indicates that the device 110 is powered without power cord plugged-in (e.g., powered by battery), the processing unit 100 may select swap behavior according to the comparison result reflecting whether the reference region is greater than the threshold; for example, the processing unit 100 may select the preserve behavior if the reference region is greater than the threshold, and select the buffer damage behavior if the reference region is not greater than the threshold. Other information, such as efficiency of copying buffer and/or whether the back buffers are external or built-in, may be included in the input data for the processing unit 100 to determine which swap behavior should be selected.

The input data may further include a learning result. For example, the processing unit 100 may adopt a first swap behavior and monitor performance, system resource consumption and/or benchmarks of executing the buffer swap; if the performance degrades, the processing 100 may switch to a second swap behavior to check if performance improves. Thus, the processing unit 100 may find and record (to the learning result) a suitable swap behavior for current scenario.

Step 406: the processing unit 100 may perform buffer swap by the selected swap behavior. For example, as shown in FIG. 4, if the selected swap behavior is the preserve behavior, the processing unit 100 may perform buffer swap by: in step 410a, with front and back buffers swapped, copying the frame in the front buffer to the back buffer; in step 412a, obtaining the dirty region as a draw region; and, in step 414a, drawing the current frame to the back buffer by updating values of at least one pixel in the draw region.

If the selected swap behavior is the buffer damage behavior, the processing unit 100 may perform buffer swap by: in step 410b, calculating a union of the dirty region and the damage region as a draw region if the union has not been calculated; and, in step 412b, with front and back buffers swapped, drawing the current frame to the back buffer by updating values of at least one pixel in the draw region.

If the selected swap behavior is the destroy behavior, the processing unit 100 may perform buffer swap by: in step 410c, with front and back buffers swapped, drawing the current frame to the back buffers by updating values of all pixels of a frame in the back buffer. That is, for the destroy behavior, the draw region is an entire frame.

Step 408: optionally, the processing unit 100 may generate current output data, while the processing unit 100 may perform the current iteration according to preceding output data of the preceding iteration. For example, the output of the preceding iteration may include a preceding dirty region reflecting a difference between the preceding frame drawn in the preceding iteration and an earlier frame drawn in an earlier iteration prior to the preceding iteration. Thus, when the processing unit 100 performs the current iteration, the preceding dirty region in the output of the preceding iteration may be utilized as the damage region to calculate the reference region and/or the draw region of the current iteration (in step 4041 or 410b); and, the current output of the current iteration may include the current dirty region reflecting a difference between the current frame and the preceding frame.

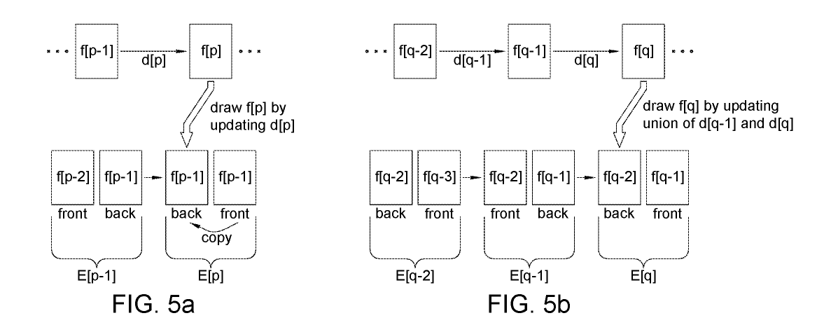

Along with FIGS. 1 and 4, please refer to FIG. 5a illustrating an example in which the processing unit 100 selects the preserve behavior to perform an iteration E[p] of step 406 for drawing a frame f[p] to the back buffer. In a preceding iteration E[p−1], a preceding frame f[p−1] is drawn to the back buffer, and a prior frame f[p−2] has been stored in the front buffer. As the iteration E[p] starts with front and back buffers swapped, the processing unit 100 may calculate a dirty region d[p] reflecting a difference between the current frame f[p] and the preceding frame f[p−1] in step 4041, decide to adopt the preserve behavior for the current iteration E[p] in step 4042. In step 410a, the processing unit 100 may copy the frame f[p−1] from the front buffer to the back buffer, obtain the dirty region d[p] as the draw region in step 412a, and, in step 414a, draw the current frame f[p] to the back buffer by updating at least one pixel value in the draw region. In step 408, the processing unit 100 may generate current output data including the dirty region d[p].

Along with FIGS. 1 and 4, please refer to FIG. 5b illustrating an example in which the processing unit 100 selects the buffer damage behavior to perform an iteration E[q] of step 406 for drawing a frame f[q] to the back buffer. In an earlier iteration E[q−2] prior to a preceding iteration E[q−1], a prior frame f[q−2] is drawn to the back buffer. Similarly, in the preceding iteration E[q−1], front and back buffers swap, a preceding frame f[q−1] is drawn to the back buffer, and preceding output data including a dirty region d[q−1] is generated, with the dirty region d[q−1] reflecting a difference between the frames f[q−1] and f[q−2].

As the iteration E[q] starts, the processing unit 100 may calculate a current dirty region d[q] reflecting a difference between the current frame f[q] and the preceding frame f[q−1] in step 4041, decide to adopt the buffer damage behavior for the current iteration E[q] in step 4042, and obtain a draw region by calculating a union of the preceding dirty region d[q−1] and the current dirty region d[q] in step 410b. Then, in step 412b, with front and back buffers swapped, the processing unit 100 may draw the current frame f[q] to the back buffer by updating at least one pixel value in the draw region. For executing steps 4042 or 410b, the processing unit 100 may obtain the preceding dirty region d[q−1] as a damage region from preceding output data generated in the preceding iteration E[q−1]; and, in step 408, the processing unit 100 may generate current output data including the dirty region d[q].

As shown by the flowchart 400, selection of swap behavior is dynamic, flexible and adaptive. For example, according to the input data, the processing unit 100 may select a first swap behavior to implement a first UI engine for a first application, and select a different second swap behavior to implement a second UI engine for a second application.

And/or, when implementing a UI engine for an application, the processing unit 100 may adopt different swap behaviors for different iterations of buffer swap to respectively draw frames for the same application. For example, the frame f[p] in FIG. 5a and the frame f[q] in FIG. 5b drawn by different swap behaviors may be different frames of the same application. The processing unit 100 may select different swap behaviors according to whether the reference region (step 4042) is greater than the threshold. For the iteration E[p] in FIG. 5a, the processing unit 100 may decide to perform buffer swap by the preserve behavior in response to a comparison result showing that the reference region calculated in step 4042 is greater than the threshold. For the iteration E[q] in FIG. 5b, the processing unit 100 may changes to perform buffer swap by the buffer damage behavior in response to a comparison result showing that the reference region calculated in step 4042 is not greater than the threshold. In other words, the processing unit 100 may change to the preserve behavior if the reference region changes to be greater than the threshold, and changes to the buffer damage behavior if the reference region changes to be not greater than the threshold.

In an embodiment, there may be two thresholds; for example, the processing unit 100 may: select the buffer damage behavior in step 4042 if the reference region is not greater than a first threshold, select the preserve behavior if the reference region is greater than the first threshold but not greater than a second threshold, and select the destroy behavior if the reference region is greater than the second threshold.

To sum up, the invention may perform buffer swap by switching among different swap behaviors according to various considerations such as chip type, power status, custom setting and differences among consecutive frames. Switching among different swap behaviors can be performed automatically. The invention may therefore avoid disadvantages of constantly adopting a same swap behavior, and leverage advantages of different swap behaviors, such as smaller draw region of the preserve behavior, and less bandwidth demands of the buffer damage behavior.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for buffer swap which swaps a plurality of buffers to respectively be a front buffer and a number of back buffers, enables a frame drawn to the front buffer to be read, and draws another frame to one of said back buffers; the method comprising:
by a processor, iterating a procedure for drawing each one of a sequence of frames, wherein the procedure comprises:
by the processor, selecting one of a plurality of swap behaviors according to input data; and
performing the buffer swap by the selected one of said swap behaviors.

2. The method of claim 1, wherein the plurality of swap behaviors comprises a preserve behavior, and performing the buffer swap by the preserve behavior comprises:
copying the front buffer to said one of said back buffers; and
drawing a current frame to said one of said back buffers by updating values of at least one pixel in a draw region reflecting a difference between the current frame and a preceding frame drawn in a preceding iteration of the procedure.

3. The method of claim 1, wherein the plurality of swap behaviors comprises a buffer damage behavior, and performing the buffer swap by the buffer damage behavior comprises:
drawing a current frame to said one of said back buffers by updating values of at least one pixel in a draw region;
wherein the draw region reflects a union of a dirty region and a damage region, the dirty region reflects a difference between the current frame and a preceding frame drawn in a preceding iteration of the procedure, and the damage region reflects a difference between contents of said back buffers in the preceding iteration of the procedure and contents of said back buffers in an earlier iteration of the procedure, wherein the earlier iteration of the procedure is prior to the preceding iteration of the procedure.

4. The method of claim 1, wherein the plurality of swap behaviors comprises a destroy behavior, and performing the buffer swap by the destroy behavior comprises:
drawing a current frame to said one of said back buffers by updating values of all pixels in said one of said back buffers.

5. The method of claim 1, wherein the procedure further comprises:
generating current output data; and
performing the buffer swap according to preceding output data generated in a preceding iteration of the procedure.

6. The method of claim 5, wherein the current output data includes a dirty region reflecting a difference between a current frame to be drawn in a current iteration of the procedure and a preceding frame drawn in the preceding iteration of the procedure.

7. The method of claim 1, wherein selecting one of the plurality of swap behaviors according to the input data comprises:
calculating a reference region at least according to a preceding frame drawn in the preceding iteration of the procedure and a current frame to be drawn in a current iteration of the procedure; and
comparing if the reference region is greater than a threshold, and including the comparison result in the input data.

8. The method of claim 7, wherein selecting one of the plurality of swap behaviors according to the input data further comprises:
selecting a preserve behavior if the reference region is greater than the threshold, and selecting a buffer damage behavior if the reference region is not greater than the threshold.

9. The method of claim 7, wherein the reference region is calculated at least by a difference between the current frame to be drawn in the current iteration of the procedure and the preceding frame drawn in the preceding iteration of the procedure.

10. The method of claim 7, wherein the reference region is calculated by a union of a dirty region and a damage region, the dirty region is calculated by a difference between the current frame to be drawn in the current iteration of the procedure and the preceding frame drawn in the preceding iteration of the procedure, and the damage region is calculated by a difference between contents of said back buffers in the preceding iteration of the procedure and contents of said back buffers in an earlier iteration of the procedure, wherein the earlier iteration of the procedure is prior to the preceding iteration of the procedure.

11. The method of claim 1, wherein the input data comprises at least one of the following:
a chip type of the processor;
a power status reflecting whether the processor is powered by battery;
a custom setting; and
a result of comparing if a reference region is greater than a threshold, wherein the reference region is one of the following: a dirty region, and a union of the dirty region and a damage region;
wherein the dirty region reflects a difference between a current frame to be drawn in a current iteration of the procedure and a preceding frame drawn in a preceding iteration of the procedure, and the damage region reflects a difference between contents of said back buffers in the preceding iteration of the procedure and contents of said back buffers in an earlier iteration of the procedure, wherein the earlier iteration of the procedure is prior to the preceding iteration of the procedure.

12. A processor comprising:
an access circuit for accessing a plurality of buffers; and
a processing unit coupled to the access circuit, for selecting among different swap behaviors according to input data to perform different iterations of a buffer swap;
wherein in each said iteration of the buffer swap, the plurality of buffers are swapped to respectively be a front buffer and a number of back buffers, and the processing unit draws one of a sequence of frames to one of said back buffers.

13. The processor of claim 12, wherein the different swap behaviors comprise a preserve behavior, and when the processing unit performs an iteration of the buffer swap by the preserve behavior, the processing unit copies the front buffer to said one of said back buffers, and draws a current frame to said one of said back buffers by updating values of at least one pixel in a draw region reflecting a difference between the current frame and a preceding frame drawn in a preceding iteration of the buffer swap.

14. The processor of claim 12, wherein the plurality of swap behaviors comprises a buffer damage behavior, and when the processing unit performs an iteration of the buffer swap by the buffer damage behavior, the processing unit draws a current frame to said one of said back buffers by updating values of at least one pixel in a draw region reflecting a union of a dirty region and a damage region;
wherein the dirty region reflects a difference between the current frame and a preceding frame drawn in a preceding iteration of the buffer swap, and the damage region reflects a difference between contents of said back buffers in the preceding iteration of the procedure and contents of said back buffers in an earlier iteration of the procedure, wherein the earlier iteration of the procedure is prior to the preceding iteration of the procedure.

15. The processor of claim 12, wherein the plurality of swap behaviors comprises a destroy behavior, and when the processing unit performs an iteration of the buffer swap by the destroy behavior, the processing unit draws a current frame to said one of said back buffers by updating values of all pixels in said one of said back buffers.

16. The processor of claim 12, wherein the processing unit performs a current iteration of the buffer swap according to preceding output data generated in a preceding iteration of the buffer swap, and further generates current output data.

17. The processor of claim 16, wherein the current output data includes a dirty region reflecting a difference between a current frame to be drawn in the current iteration of the buffer swap, and a preceding frame drawn in the preceding iteration of the buffer swap.

18. The processor of claim 12, wherein when the processing unit performs a current iteration of the buffer swap, the processing unit further:
calculates a reference region at least according to a preceding frame drawn in the preceding iteration of the buffer swap and a current frame to be drawn in the current iteration of the buffer swap; and
compares if the reference region is greater than a threshold, and includes the comparison result in the input data.

19. The processor of claim 18, wherein the processing unit changes to a preserve behavior if the reference region changes to be greater than the threshold, and changes to a buffer damage behavior if the reference region changes to be not greater than the threshold.

20. The processor of claim 12, wherein the input data comprises at least one of the following:
a chip type of the processor;
a power status reflecting whether the processor is powered by battery;
a custom setting; and
a result of comparing if a draw region is greater than a threshold, wherein the draw region is one of the following: a dirty region, and a union of the dirty region and a damage region;
wherein the dirty region reflects a difference between a current frame to be drawn in a current iteration of the buffer swap and a preceding frame drawn in a preceding iteration of the buffer swap, and the damage region reflects a difference between contents of said back buffers in the preceding iteration of the procedure and contents of said back buffers in an earlier iteration of the procedure, wherein the earlier iteration of the procedure is prior to the preceding iteration of the procedure.
